(19) United States
(12) Patent Application Publication
(10) Pub. No.: US 2025/0346800 A1
(43) Pub. Date: Nov. 13, 2025

(54) NANOBUBBLE FOR IMPROVING SCAVENGER EFFICIENCY

(71) Applicant: Halliburton Energy Services, Inc., Houston, TX (US)

(72) Inventors: Pratiksha Vinodkumar Farad, Katy, TX (US); Ronald Bosch, Houston, TX (US)

(21) Appl. No.: 18/659,720

(22) Filed: May 9, 2024

(51) Int. Cl. C09K 8/532

(52) U.S. Cl. CPC C09K 8/532; C09K 2208/06; C09K 2208/10; C09K 2208/20

(57) ABSTRACT

Described herein are methods and materials for increasing the scavenging efficiency of hydrogen sulfide collected or produced in subterranean formations during wellbore environments. The methods can include first identifying a location that may include a concentration of production fluid that may contain high concentrations of H₂S gas. The production fluid may be initially collected and tested to determine the concentration of H₂S gas within the production fluid mixture. The production fluid, after testing, may then be treated, using in-line injection methods including a concentration of scavenging material to scavenge H₂S gas from the production fluid and produce a cleaner gas after treatment.

### TECHNICAL FIELD

The present disclosure relates generally to wellbore operations and, more particularly (although not necessarily exclusively), to materials and methods for improving sour gas scavenging efficiency for use in wellbore or production operations.

### BACKGROUND

The term sour gas is synonymously known as natural gas that contains a measurable amount of hydrogen sulfide (H₂S). Sour gas released during wellbore or hydrocarbon operations of subterranean formations may be corrosive and may cause damage to wellbore equipment as well and may pose health and safety concerns. Thus, methods for treating sour gas can be employed in oil field and hydrocarbon production operations, including but not limited to, during drilling operations. One method involves the use of bubble tower reactors however, current methods employing these towers may not be cost effective, may be time consuming, removal of material may be inefficient, and the systems, when operated incorrectly, can lead to the production of foam in the system, which may cause inadequate scavenging.

### BRIEF DESCRIPTION OF THE DRAWINGS

FIG. 1 is a schematic of an example of a wellbore environment with a flowline for carrying fluids from the wellbore an onsite location for further processing, according to examples of the present disclosure.

FIG. 2 is a cross sectional view of a well system for drilling and collecting hydrocarbons from the subterranean formation whereby sour gas in the subterranean formation may be released and collected according to examples of the present disclosure.

FIG. 3 is a block diagram of a method for treating sour gas released from a subterranean formation according to examples of the present disclosure.

FIG. 4 is a block diagram of a method for treating sour gas downhole released from a subterranean formation according to examples of the present disclosure.

FIG. 5 is an example schematic of the bubbles produced in a confined space reactor according to examples of the present disclosure.

FIG. 6 is an example schematic of a system for injecting a liquid in the form of nanobubbles into a flow path according to examples of the present disclosure.

### DETAILED DESCRIPTION

Certain aspects and examples of the present disclosure involve materials and methods for improving the efficiency of H₂S scavenging using in-line injection methods. Subterranean formations commonly produce and contain gases. For example, H₂S may be produced from multiple sources and can be entrapped or contained in subterranean formations. In a first scenario, H₂S can be produced by sulphate-reducing bacteria in formation water at formation conditions to reduce sulphate to H₂S. In a second scenario, H₂S gas may be produced in a process known as aquathermolysis. The process entails injecting steam into a reservoir at high temperature and pressure causing a thermochemical production of H₂S, CH₄, CO₂, CO, and H₂ from organosulfur species or metal sulfides. In a third scenario, H₂S may be produced via thermochemical sulfate reduction (TSR). TSR is a process wherein sulfate minerals and oxidation of hydrocarbons occurs at temperatures above 100° C. in the formation.

Over time, the concentration of H₂S may increase as more sulfate minerals are reduced. Gas released from subterranean formations during wellbore operations or produced as byproducts from reactions may be a mixture of multiple types of gas. For example, the gas mixture may include CO, CO₂, CH₄, and H₂ gas. In the event the gas has measurable amounts of H₂S, it is commonly referred to as sour gas. Sour gas may refer to a gas that has at least four (4) ppm of H₂S in the gas and oil mixture. Methods for removing H₂S from production fluids may utilize triazine or other scavenging materials. For example, triazine is a nitrogen containing heterocyclic compound, in the presence of H₂S, a first substitution occurs to produce dithiazine followed by further substitutions until triathine is produced. Other sources of produced H₂S can include the bacterial decomposition of human and animal waste presenting as an emission from sewage treatment facilities and landfills, petrochemical plants, coke oven plants, and kraft paper mills.

Removal of H₂S gas from the gas byproducts of the above-mentioned methods may be of interest for environmental reasons. For example, during well drilling and hydrocarbon production operations H₂S gas collected and produced from the formation may have high concentrations of H₂S resulting in the classification of sour gas. The sour gas must be treated to remove H₂S from the gas and create a cleaner gas mixture or oil mixture or in other terms make the gas sweet (for example, reduce the H₂S to below 4 ppm). In some embodiments, H₂S gas may be scavenged from the gaseous mixture (also referred to herein as the production fluid) using in-line injection methods.

Common methods for removing H₂S gas from the gas mixture or oil mixture (e.g., production fluid) include diverting gas released during the production operation or wellbore operation to separate gas from oil. Subsequently, the gas may undergo processes involving additional equipment, such as bubble tower reactors, or ultra-fab systems to reduce the H₂S concentration in the gas mixture before the gas may be sold. During scavenging processes, the efficiency of removal may be impacted by the surface area of the bubbles, the concentration of the solution, and bubble path time (contact time). Additionally, the use of such towers may increase cost by requiring more equipment, may increase time required for removing H₂S, and may require more chemicals for removal of sour gas. For example, in environments where the bubbles are heterogenous, the differences in size distribution of the gas bubbles may lead to inefficient removal of harmful gas from the gas mixture. Additionally, the larger the bubble, the faster they rise through the solution thereby decreasing contact time with the scavenging material. In an alternate scenario, the concentration of scavenging material within the solution may need to be increased to account for the non-uniformity of the bubbles. The increase of the scavenging material, for example triazine, may be harmful to the environment.

In contrast, embodiments of the present disclosure can increase efficiency of scavenging and allow for systematic alterations to the scavenging methods to alter the scavenging process when applied to different environments. For example, the amount, size, pressure, and gas content of bubbles produced within the flowline or pipeline can be controlled to adjust scavenging. Additionally, the solution used for scavenging can be controlled such that the concentration of triazine or other scavenging chemical used can be changed allowing for controlling of chemical moieties. This can allow for a more efficient, cost effective, and cleaner removal of various gases within the gas mixture. Embodiments of the present disclosure can also be used to remove other gases in addition to H₂S from gas and oil released or produced during drilling and production operations by changing the scavenging material and the input gas. In some embodiments, the in-line methods may eliminate the reactors or capturing facility that are commonly utilized for capturing H₂S while simultaneously maintaining the same capturing capability of H₂S.

In a particular example, the methods disclosed herein may include injecting nanobubbles directly into a flow line or pipeline. The injection of nanobubbles directly into the flowline or pipeline may allow for the reduction in chemicals and materials cost as well as an increase in efficiently scavenging of H₂S from the production fluid. For example, in an in-line treatment process, the nanobubbles may be produced by using a carrier gas or carrier liquid that is injected, into a gas stream that is flowing, as a droplet through an atomizer. Such atomizer functions may produce nanobubbles that may increase the contact time of the scavenging material with the production fluid and may reduce the falling-out process of the scavenging material. The use of the nano-bubbler may increase contact time and surface area of the gas bubbles inside of the flowline or pipeline. In some embodiments, the methods described herein may be employed on alternate, less H₂S-rich gas streams.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

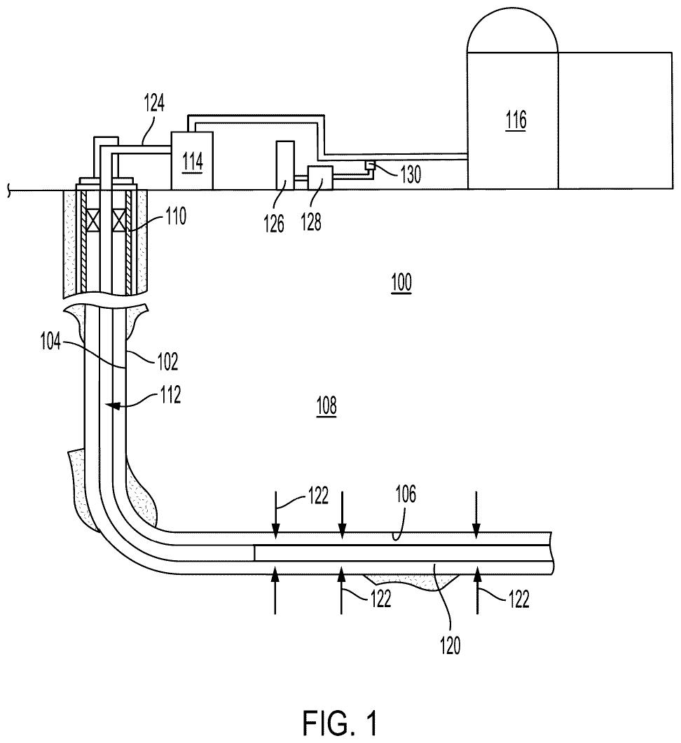

FIG. 1 is a schematic of an example of a wellbore environment 100 that may include a wellbore 102 with a generally vertical section 104 that transitions into a generally horizontal section 106 extending through the subterranean formation 108. The wellbore 102 may include casing string 110 and a production tubing string 112 that may extend from the surface through the wellbore 102 into the subterranean formation 108. Fluid 122 may be produced from multiple intervals of the formation 108 through portions of the anulus 120. The production tubing string 112 can provide a conduit for formation fluids, such as production fluids from the subterranean formation 108, to travel to the surface. The production fluid (e.g., oil and gas) generated, or collected during operations may be pumped to the surface through the vug and into the flowlines 124. The pipe may transport the production fluid through to the production tubing string 112 and through a valve located at the top of the well production before it is further transported through the flowlines 124. The production fluid may be gathered from a singular well or a number of wells. The production fluid may be passed through a separator (not shown) where a larger percentage of the water may be removed from the mixture and if there are any hydrocarbon liquids, they are subsequently captured. The water may be disposed after removal. The fluid may first be transported through flowlines 124 to processing equipment 114 before flowing through the remaining flowlines 124 to a treatment facility 116 for further processing, according to one aspect of the present disclosure.

As the fluid from downhole is pumped through the flowlines 124, they may be first treated at processing equipment 114. The processing equipment 114 may be used to first remove coarse material from the fluid passing through the flowlines 124 before reaching the treatment facilities 116. For example, the processing equipment 114 may include a fluid processing system on the surface of the production well 102. The fluid processing system may be used to perform centrifugation of the sample, coarse and fine filtration for the sample, distillation or selective flocculation of polymers or drill solids in the sample. Distillation can involve separating solids from liquids and retaining both the solid phase and the liquid phase for analysis. The coarse and fine filtration of the sample can involve filtering the sample into filtrate and filter-cake. Either the filtrate or the filter-cake may be analyzed to quantify additives in the sample.

The fluid processing system, as part of the processing equipment 114 may also be used to perform selective extraction, in which a solvent can be utilized that selectively extracts a compound of interest into the solvent, separating the compound of interest from other components of the drilling fluid. Any other type of processing may be performed on the sample. In some embodiments, the fluid processing system 114, may be positioned near or inside of the onsite treating facilities 116 located on site. In some embodiments, the processing equipment 114 may include methods of testing the H2S concentration in the production fluid. Upon determination of the H2S concentration, the fluid may be treated, using a nanobubble generator 128 in fluid communication with a storage tank 126 for producing nanobubbles coated with the scavenging material as described herein. The nanobubble generator may be in gas communication with the nanobubble generator 128 for producing the nanobubbles to scavenge H2S. The nanobubble generator 128 may be in further communication with a quill 130 for injecting the nanobubbles into the flowline 124. One skilled in the art may understand that the quill 130 and nanobubble generator 128 with the storage tank 126 may be positioned in a singular position, in multiple positions, and may be anywhere along the flowline 124 before the treating facility 116 wherein a compressor may be positioned.

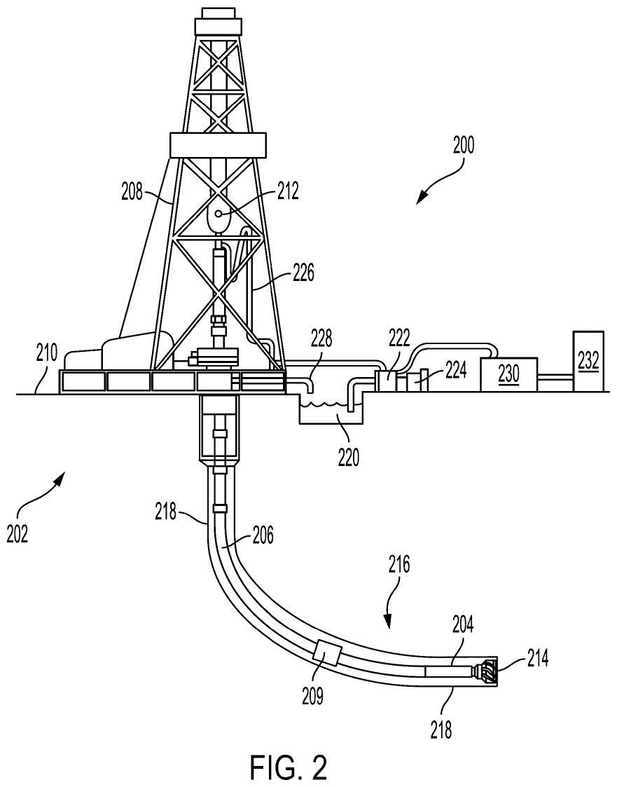

FIG. 2 is a cross sectional view of a well system for drilling, releasing, and collecting hydrocarbons from the subterranean formation whereby sour gas in subterranean formations may be released and collected according to one example of the present disclosure. A wellbore 218 used to extract hydrocarbons may be created by drilling into a subterranean formation 202. The well system 200 may include a bottom hole assembly (BHA) 204 positioned or otherwise arranged at the bottom of a drill string 206 extended into the subterranean formation 202 from a derrick 208 arranged at the surface 210. The derrick 208 includes a kelly 212 used to lower and raise the drill string 206. The BHA 204 may include a drill bit 214 operatively coupled to a tool string 216, which may be moved axially within the drilled wellbore 218 as attached to the drill string 206. The combination of any support structure (in this example, derrick 208), any motors, electrical equipment, and support for the drill string 206 and tool string 216 may be referred to herein as a drilling arrangement.

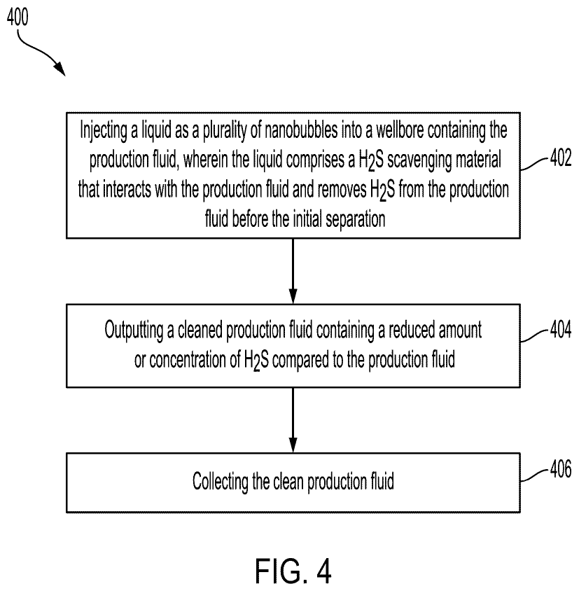

During operation, the drill bit 214 can penetrate the subterranean formation 202 to create the wellbore 218 where sour gas may be located. The BHA 204 can provide control of the drill bit 214 as the drill bit 215 advances into the subterranean formation 202. The combination of the BHA 204 and drill bit 214 can be referred to as the drilling tool. Fluid or “drilling mud” from a mud tank 220 may be pumped downhole using a mud pump 222 powered by an adjacent power source, such as a prime mover or motor 224. In some embodiments, the methods described herein, and further explained in FIG. 4, may be employed downhole in the wellbore 218 where sour gas may be located. The method may include a storage tank 232 in liquid communication with a nanobubble generator 230. The nanobubble generator 230 may be in liquid and gas communication with the pump 222 for injecting the nanobubble composition down hole. For example, the nanobubbles, including the scavenging material coating on the surface of the nanobubbles, may be generated, via the nanobubble generator 230 and injected, using the pump 222 and other surface equipment to inject the nanobubbles into the subterranean formation 202 via the wellbore 218. The storage tank 232 may include the scavenging material dissolved in a liquid such as water, or brine, and may be injected into the nanobubble generator. In some embodiments, the nanobubble generator may include an injection port for injecting a carrier gas that may be the internal space of the nanobubble. The carrier gas may be an inert gas or a lease gas collected during wellbore operations.

Alternatively, assemblies may be in place for pumping gas out of the subterranean formation through pipes and lines into storage tanks or holding tanks to be processed. In some embodiments, systems may be in place for pumping steam down a formation to stimulate a formation for hydrocarbon production. During such process H₂S gas may be generated as described above. In such scenarios, production fluid (e.g., oil and gas) generated, or collected during operations may be pumped to the surface through the vug and into the pipes. The pipes may transport the production fluid through to the production string and through a valve located at the top of the well production before it is gathered. The production fluid may be gathered from a singular well or a number of wells. The production fluid is passed through a separator where a larger percentage of the water is removed from the mixture and if there are any hydrocarbon liquids, they are subsequently captured. The water may be disposed after removal. As the remaining mixture flows through the remainder of the pipeline the production fluid may cool and the pressure may decrease along the length of the pipeline. In some embodiments, the water may be separated from the remainder of the flowline by use of a separator that comprises a pot having an impulse mechanism that drops the water into a gathering system. An impulse system may refer to a system having the potential to open when a liquid is on it and close when there is no more water or liquid retained on top. The mechanism may be any known mechanism to prevent the loss of gas while removing any liquid from the mixture. In some embodiments, the H₂S gas in the production fluid may be measured periodically via in-line sensors, on-line, or separately from the production lines. The concentration of H₂S may be below the 4 parts per million threshold when measured at the compressor located along the production lines where the gas may be collected for future use. For example, at compression the gas must be at or below the threshold limit of H₂S and must be treated to become dry, where the moisture content must be below a given threshold.

During the generation of the nanobubbles for use in scavenging H₂S gas from the production fluid, a gas may be injected through an atomizer as the scavenging material liquid is injected in parallel. The co-injection may create nanobubbles that include an inner core having or being filled with a gas and an outer layer coating the nanobubble having the scavenging material. In some embodiments, the scavenging material is on the outer surface of the nanobubble to create a coating around the nanobubble. This external coating on the bubble may allow for longer contact time of the scavenging material with the H₂S both in the gas phase and dissolved in the oil mixture. In some embodiments, the scavenging material as the coating on the surface of the gas nanobubble may be similarly referred to as a liquid-infused surface with entrapped air (LISTA). The trapped air may be the carrier gas and can include an inert gas or lease gas. In some embodiments, surfactant may be introduced in combination with the scavenging material, to produce a homogenous liquid that may be injected into the atomizer, to create a uniform coating on the outer layer of the nanobubble.

In some embodiments, the flowlines and pipelines may include a quill, in gas communication, for injecting chemicals into the flowline or pipeline and an injection valve for injecting a carrier gas immediately before the nanobubble generator. The quill may be used for distributing the nanobubbles including the scavenging material coating into the center of the pipeline or flowline. For example, the system may include pipes for diverting the sour gas downstream of the pump and introduce the nanobubble generator to controllably produce the nanobubbles. For example, the nanobubbles may be lease gas from the flow line. The gas passing through the stream may break up the foam that is being generated to maximize contact time of the scavenging material on the surface of the nanobubbles. In some embodiments, if the pipeline or flowline turns vertical, they may be held up and may not flow through the vertical pipelines allowing for longer contact in the production fluid. In some embodiments, the system utilized for injecting the nanobubbles into the flowline or pipeline may include a flowline exterior to the main flowline having injection ports and valves disposed along the tubing for injecting chemicals, liquids, or gases positioned before or after the nanobubble generating machine. The device may further include the quill positioned to allow insertion into the main flowline for injecting the produced nanobubbles. In some embodiments, the methods described herein may be employed in more than one location along the pipeline or flowline for injecting nanobubble scavenging material in a singular location or in multiple locations along the flowline or pipeline.

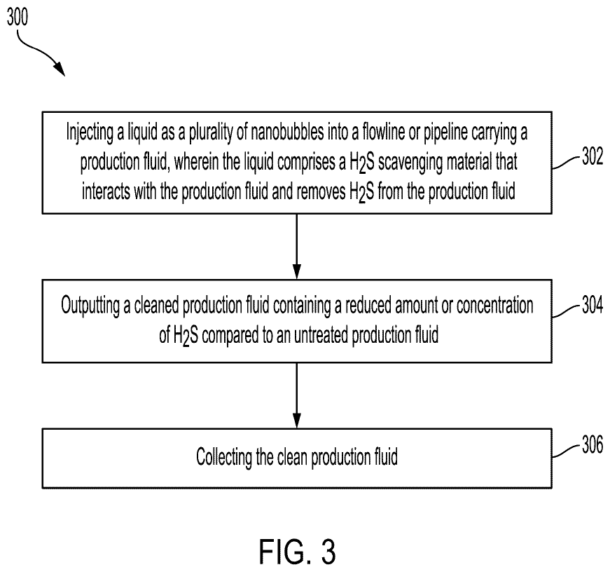

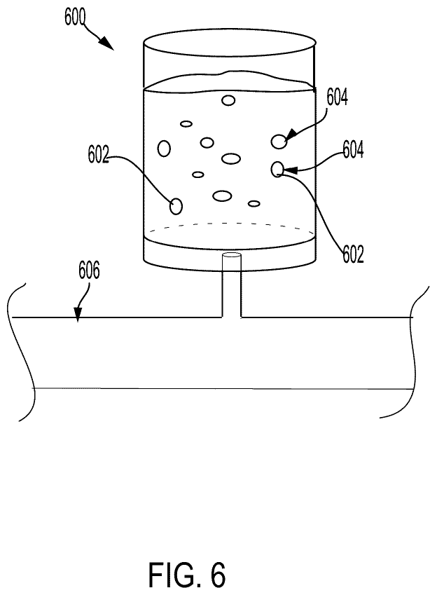

FIG. 3 is a block diagram of a process 300 for treating sour gas released from a subterranean formation in a flowline or pipeline according to one example of the present disclosure. At block 302, a liquid may be directly injected as a plurality of nanobubbles into a flowline or pipeline. The liquid may be injected as nanobubbles by providing generating a nanobubble via a carrier gas and providing a liquid coating on the nanobubble surface, the liquid coating may be a scavenging material. In such an example, the liquid being injected as nanobubbles into the pipeline or flowline may refer to the liquid coating on the nanobubble surface (e.g., liquid coating being the scavenging material), for example as depicted in FIG. 6. By providing the liquid as a coating on the nanobubble surface, sour gas may be treated via the nanobubble comprising a carrier gas (e.g. for forming the nanobubbles) and a scavenging material (e.g. the liquid coating on the nanobubble surface). The liquid may include an H₂S scavenging material that interact with the production fluid and removes H₂S from the oil. For example, H₂S gas is more soluble in oil when compared to water, thus injecting scavenging material into in-line applications, H₂S in both liquid and gas phases may be scavenged. Nanobubbles may provide more surface area between a chemical (e.g., the scavenging material) and the surrounding liquid (e.g., the H₂S) which may aid in increasing scavenging of H₂S gas dissolved in a water phase. Nanobubbles may also improve solubility of gases in chemicals which may help solubilize more H₂S gas in the scavenger. Nanobubbles may also alter reaction kinetics and aid in reducing waste, for example by reducing the quantity of chemicals required. In some embodiments, the nanobubbles are of a controlled size ranging from 1 nm to 1000 nm in diameter. In some embodiments, the liquid may be added internal, or before the nanobubbles are formed, internal to the device for making the nanobubbles, or after the nanobubbles are generated. For example, if the liquid is introduced after, a spray system may be placed after the nanobubble machine and a spray, or mist, may be introduced to the nanobubbles as they are generated to create the thin coating on the surface. In the event that the liquid is introduced into the nanobubble directly, the process may be a simultaneous generation of nanobubbles having a thin coating of scavenging material liquid on the surface. It may be understood by those skilled in the art that the method for generating nanobubbles may be any known method for producing nanobubbles and depositing a thin coating on the surface.

At block 304, the cleaned production fluid containing a reduced amount or concentration of H₂S compared to the production fluid is output. For example, the cleaned production fluid may be output when the reduced amount or concentration of H₂S in the cleaned oil mixture corresponds to removal of 99% more of the H₂S from the production fluid. In some embodiments, if the production fluid is not cleaned, the production fluid may be recirculated through the pipeline or flowline to further treat the production fluid. In some embodiments, to improve scavenging efficiency, retention loops may be installed and in fluid communication with the flowlines or pipeline to allow for a longer reaction time between the scavenging material and the production fluid. In some embodiments, after the plurality of nanobubbles have scavenged the H₂S gas from the production fluid it may be recycled from the mixture and the scavenging material that was not reduced to scavenge H₂S may be recycled to produce new nanobubbles. In some embodiments, the recycled liquid may be the carrier liquid. In some embodiments, the surfactant in the recycled liquid may be used as the primary surfactant to reduce chemical use or cost of production.

At block 306, the cleaned production fluid is collected. In some embodiments, the cleaned production fluid is analyzed using techniques known by those skilled in the art to assess the concentration of H₂S in the production fluid. The production fluid may be deemed clean if the concentration of H₂S is at or below a threshold limit as set by regulatory bodies for the given operation being conducted. In some embodiments, when the clean production fluid is not at or below the threshold limit, the composition or condition of the scavenging liquid mixture is modified to adjust an amount or concentration of H₂S in the cleaned production fluid. The modifications may include adjusting a temperature of the scavenging material, adjusting a pressure of the scavenging material injected into the flowline or pipeline, adjusting an amount or concentration of the H₂S scavenging material in the liquid, or adjusting a flow rate of the liquid into the flowline or pipeline.

In some embodiments, retention loops may be attached or connected to be in fluid communication with the pipelines or wellbore flowlines to further improve the efficiency of scavenging. Injecting the scavenging material directly into the flowline, pipeline, or wellbore application may reduce the quantity of chemicals required for scavenging and thereby may also reduce waste. In some embodiments, the methods described herein may be used in downhole applications. The scavenging material selected may be triazine. The triazine in the liquid may be at a concentration of between 1 ppm and 10000 ppm. In some embodiments, the concentration of the H₂S scavenging material in the liquid is in excess by up to or at least 25% as compared to a removal capacity of the H₂S scavenging material for the H₂S in the oil mixture. In some embodiments, a surfactant may be included in the scavenging material to further reduce the aggregation potential of particles to one another and increase the stability of the nanobubbles and thus, increase efficiency of scavenging. For example, the surfactant may be selected from any one of the flowing chemicals including, HC-2® surfactant or PEN-5M® surfactant. In some embodiments, the surfactant may be selected from the group including alkyl amines, alkylamine salts, alkylamidobetaines such as cocoamidopropyl betaine, trimethylallowammonium chloride, trimethylcocoammonium chloride, cocoamidopropyl betaine, amide quarternary ammonium surfactants with a chemical formula CₙH₂ₙ₊₁CONH(CH₂)₂N⁺(CH₃)3·CH3CO3- (n=9, 11, 13, 15), 2-(2-butoxyethoxy) ethanol, 2-(2-ethoxyethoxy) ethanol, 2-(2-methoxyethoxy) ethanol, 2-butoxyethanol, 2-ethoxyethanol, 2-ethoxyethyl acetate, bis(2-methoxyethyl) ether, alkoxylated nonylphenols, alkyloxylated lineral alcohols, alkyloxylated branched chain alcohols, propylene oxide condensate block copolymers, salts of aliphatic sulfonic acids, alpha-olefin sulfonate, C8 to C22 alkylethoxylate sulfate, surfactants sold under the trade names Transcend™ 425 or Transcend™ 725, N-(phosphonmethyl)iminodiacetic acid, or any combination thereof.

FIG. 4 is a block diagram of a method for treating sour gas downhole released from a subterranean formation according to one example of the present disclosure. At block 402, the method includes injecting a liquid as a plurality of nanobubbles, for example injecting a plurality of nanobubbles having a liquid coating, directly downhole in the wellbore containing the production fluid, wherein the liquid comprises H₂S scavenging material that interacts with the production fluid and removes H₂S from the production fluid before the initial separation occurs. In such a system, the method may be performed in a similar manner described throughout this disclosure. In some embodiments, the methods described herein may be employed in wet gas wells in unconventional production. Such methods described herein may be used to efficiently remove sour gas from the gas mixture even though the flow of gas mixture is fast making conventional methods not efficient and highly costly. In some embodiments, in wet gas wells in unconventional production, the method may include disposing a string down a well or injecting the plurality of nanobubbles through the casing with the tubing flowing well. The method may include injecting the plurality of nanobubbles into the heel of the well. Such method may improve water separation and increase the efficiency of scavenging of the scavenging material. In some embodiments, a surfactant may be injected in combination with the scavenging material liquid for producing the nanobubbles. The surfactant may be selected from the group including alkyl amines, alkylamine salts, alkylamidobetaines such as cocoamidopropyl betaine, trimethylallowammonium chloride, trimethylcocoammonium chloride, cocoamidopropyl betaine, amide quarternary ammonium surfactants with a chemical formula CₙH₂ₙ₊₁CONH(CH₂)₂N⁺(CH₃)3·CH3CO3- (n=9, 11, 13, 15), 2-(2-butoxyethoxy) ethanol, 2-(2-ethoxyethoxy) ethanol, 2-(2-methoxyethoxy) ethanol, 2-butoxyethanol, 2-ethoxyethanol, 2-ethoxyethyl acetate, bis(2-methoxyethyl) ether, alkoxylated nonylphenols, alkyloxylated lineral alcohols, alkyloxylated branched chain alcohols, propylene oxide condensate block copolymers, salts of aliphatic sulfonic acids, alpha-olefin sulfonate, C8 to C22 alkylethoxylate sulfate, or any combination thereof.

At block 404, the cleaned production fluid in the wellbore containing a reduced amount or concentration of H₂S compared to the crude mixture is pumped from downhole. In some embodiments, the method may include equipment commonly used for performing the production operation including pumps for transporting the fluids.

At block 406, the cleaned production fluid is collected. In some embodiments, the cleaned production fluid is analyzed using techniques known by those skilled in the art to assess the concentration of H₂S in the production fluid. The production fluid may be deemed clean if the concentration of H₂S is at or below a threshold limit as set by regulatory bodies for the given operation being conducted. In some embodiments, when the clean production fluid is not at or below the threshold limit, the composition or condition of the scavenging liquid mixture is modified to adjust an amount or concentration of H₂S in the cleaned production fluid. The modifications may include adjusting a temperature of the scavenging material, adjusting a pressure of the scavenging material injected into the flowline or pipeline, adjusting an amount or concentration of the H₂S scavenging material in the liquid, or adjusting a flow rate of the liquid into the flowline or pipeline. In some embodiments, if the cleaned production fluid is not cleaned from treatment downhole in the wellbore, the methods described herein may be performed in the flowline or pipeline to further reduce the concentration of H₂S gas to meet safety requirements.

In some embodiments, the temperature of the scavenging material or the oil mixture may also be controlled. For example, the temperature may be maintained at a temperature range from 50° F. up to 300° F., or from 50° F. to 100° F., from 100° F. to 150° F., from 150° F. to 200° F., from 200° F. to 250° F., or from 250° F. to 300° F. For example, the temperature of the scavenging material may be adjusted to improve the coating potential on the nanobubble or for improving the scavenging efficiency of the scavenging material. In some embodiments, gas within the production fluid may also be controlled. In some embodiments, the methods described herein may be employed in conventional wells, conventional production operations, unconventional wells, or any and all types of production and well operations.

In some embodiments, gas within the production fluid may also be controlled for improving the efficiency of scavenging. For example, the carrier gas and other gasses may be injected into the production fluid or removed from the production fluid before the gas in passed through the production lines to the compressor. In some embodiments, the system may comprise a injection port for injecting a carrier gas or a scavenging material to remove unwanted gasses before injection of the scavenging material coated nanobubbles. In some embodiments, where the CO₂ gas is present within the gas mixture the efficiency of scavenging may be decreased. In such embodiments, the CO₂ gas within the gas mixture may be controlled for improving the efficiency of scavenging. For example, the CO₂ gas concentration in the gas mixture may be first reduced before the gas mixture passes further in the flowline or pipeline where the scavenging material coating the nanobubbles is being injected. In some embodiments, decreasing the concentration of CO₂ in the gas mixture before the gas passes through the nano-bubbler may increase the efficiency of removal of H₂S from the gas mixture. For example, the CO₂ concentration may be reduced in the gas mixture by at least 5% by volume, by at least 10% by volume, by at least 15%, by at least 20%, or by at least 25% by volume.

In some embodiments, the scavenging material used to remove H₂S from the water phase and the gas phase may be categorized into three groups. For example, water-soluble scavengers, oil-soluble scavengers, and metal-based scavengers. Water-soluble scavenging material may be the most common product of choice for applications at temperatures below 200° F. (93° C.). Such water-soluble scavengers may include triazine. In some embodiments, oil-soluble scavengers may be used in high temperature applications or when water tolerance of the hydrocarbon is an issue. For example, oil-soluble scavengers may be amine-based compounds such as alkylamine formaldehyde condensate. In some embodiments, the metal-based scavenger may be used in embodiments where a specific need of very-high temperature and high-H₂S concentration applications. For example, for treatment of asphalt.

Triazine compounds may have added benefits because they can be modified to become more or less hydrophilic by using different side groups on the nitrogen atoms. In some embodiments, a hydroxyethyl-side group may be used. In an alternate embodiment, the triazine may be substituted with purely non-polar side groups. For example, shown below are structures of triazine compounds, 1,2,3 triazine, 1,2,4 triazine, and 1,3,5 triazine. The R groups may be independently selected from hydrogen, nitrogen, chlorine, bromine, alcohol, methyl, alkyl groups, aryl groups, or an amino group.

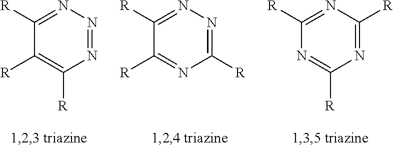

In some embodiments, the concentration of the scavenging material may be increased or decreased based on the concentration of H₂S in the production fluid. For example, triazine, when unreacted, is toxic while byproducts, such as dithiazine, are non-toxic and can be further treated out of solution. When the concentration of triazine is too much in excess of the H₂S gas, unreacted triazine may be left in solution, thus the appropriate concentration of triazine must be selected such that after scavenging, there is minimal to no unreacted triazine. For example, the concentration of triazine may be from 10 gram per liter (g/L) to 200 g/L in the total solution. In some embodiments, the ratio of scavenging material to H₂S is from 1:1 to 4:1. In some embodiments, the scavenging material is in excess of H₂S by at least 25% when compared to the removal capacity of the H₂S scavenging material for the H₂S in the gaseous mixture or the reduced amount or concentration of H₂S in the cleaned gaseous mixture corresponds to removal of 99% or more of the H₂S from the gaseous mixture. In some embodiment, other chemical additives may be added to the carrier gas or carrier liquid. In some embodiments, the carrier liquid may be water, brine, or oil. For example, buffers may be added to solution. By controlling the concentration of triazine such that the reaction efficiency is at or near 100% and there is minimal unreacted triazine, the cost may be significantly reduced. In some embodiments, alternate scavenging materials may be used. For example, the methods described herein may be employed with alternate H₂S scavenging materials in solution.

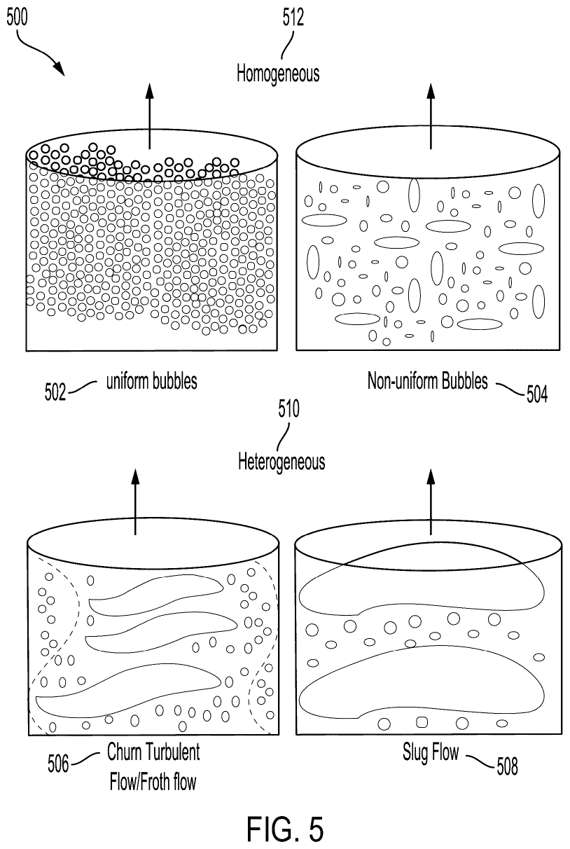

FIG. 5 provides example schematics of the types of bubbles produced in confined spaces filled with liquids according to one or more examples of the present disclosure. The bubbles, when passing through a flowline or pipeline via injection through the quill may be of different sizes or different flow patterns. For example, the homogenous or heterogenous bubbles discussed below may be generated in-line and thus may impact the efficiency of scavenging. Bubbles generated for use in this field may be non-uniform or inconsistent (see non-uniform bubbles 504). For example, the bubbles may be heterogeneous. Heterogeneous bubbles 510 may cause imperfect or bad bubbles. The imperfect bubble creation may reduce efficiency of scavenging. In some embodiments, the heterogeneous bubbles may cause churn turbulent 406 in the flowline or pipeline. Churn turbulent may refer to a two-phase gas/liquid flow regime characterized by a highly-agitated flow where gas bubbles may be sufficient in numbers to both interact with each other and, while interacting, coalesce to form larger distorted bubbles with unique shapes and behaviors in the system. Churn turbulent flow may be created when there is a large gas fraction in a system with a high gas and low liquid velocity. In in-line applications, churn turbulent may be insufficient for removal of H₂S gas. In some embodiments, the heterogeneous flow of gas created by the nano-bubbler may be a slug flow 508. Slug flow may refer to a gas flow in an in-line flowline or pipeline that causes large pockets of gas bubbles to separate large pockets of liquid, thus creating less surface area of contact between the liquid and the gas phases including the scavenging material and the H₂S gas. In some embodiments, the device for creating the nanobubbles described above may be used to create a more uniform flow of gas bubbles. In some embodiments, the nano-bubbler may create a flow of bubbles that do not generate a foam in the solution, providing a clean and efficient source of bubbles in the flowline or pipeline. The nano-bubbler used in in-line applications may produce homogenous bubbles 512. In such an event homogenous bubbles 512 are used to refer to a nano-bubbler that may produce bubbles in a consistent manner. However, the homogenous bubbles 512 system may include non-uniform bubbles 504. In this environment, while the device used for generating nano-bubbles is consistently producing bubbles, the bubbles produced may be non-uniform 504 in size and shape where some are larger than others, or others are produced as ovular shapes instead of circular. This non-uniformity may impact scavenging efficiency by reducing the surface area of the bubbles within the liquid.

The nanobubbles produced using a nano-bubbler may be referred to as uniform bubbles 502 according to examples of the present disclosure. Uniform bubbles may be used to describe the homogeneous production of bubbles in the in-line flowline or pipeline. The homogeneous bubbles 512 may be nanoparticle sized. For example, the bubbles produced in the nano bubbler may be from 1 nm to 1000 nm as described above. The uniform bubbles 502 produced may provide an environment for the highest efficiency of scavenging due to the higher surface area in total across all the bubbles produced. Additionally, the uniform production of bubbles may not create pockets of larger bubbles resulting in scavenging loss and H₂S making it through the system. The nanobubbles may be a homogenous size, or within ±10 nm of one another. For example, the nano bubbles may be from 10 nm to 20 nm, from 20 nm to 30 nm, from 30 nm to 40 nm, from 40 nm to 50 nm, from 50 nm to 60 nm, from 60 nm to 70 nm, from 70 nm to 80 nm, from 80 nm to 90 nm, from 90 nm to 100 nm, up to 1000 nm in 10 nm increments. The flow rate of the gas into the flowline or pipeline may be controllable to adjust the retention time of the nanobubbles in the liquid. The production fluid collected from the wellbore or subterranean formation may be introduced with the nanobubbles using a carrier gas or carrier liquid. In some embodiments, the carrier gas may be a natural gas, for example, methane. In an alternate embodiment, the carrier gas may be a gas supply that is non-reactive with the presence of oxidizers. In some embodiments, the non-reactive gases may include argon, carbon dioxide, helium, and nitrogen gas, herein referred to as an inert gas. The non-reactive gas may be injected into the subterranean formation or wellbore to aid in removal of the trapped sour gas underground and transport the gas mixture into the pipelines or flow lines.

It may be understood by those skilled in the art that the plurality of nanobubbles injected into the flowline or pipeline may be injected at any point in the pipeline or flowline that comes after the pump and before the compressor positioned along the flowline or pipeline. For example, the quill may be positioned just after the pump for introducing the nanobubbles into the flowline or pipeline. The positioning of the quill may be adjusted along any port on the flowline or pipeline that may allow sufficient time for the scavenging material to interact with the sour production fluid. In some embodiments, the system may include a separator for removing the nanobubbles maintained in solution or to isolate the scavenging material to prevent the material from flowing through to the compressor.

FIG. 6 depicts a schematic diagram of a system 600 for injecting a liquid, for example a scavenging material, in the form of nanobubbles 602 into a flow path 606. The nanobubbles 602 may be formed by a carrier gas and may include a liquid coating 604 on the outer surface of each nanobubble 602, the liquid coating 604 may be a scavenging material. The nanobubbles 602 may be injected into the flow path 606 which may be carrying a production fluid, as described above with respect to FIGS. 3 and 4. The flow path 606 may be a pipeline or flowline. In various examples herein, reference to the liquid being injected as nanobubbles into the pipeline or flowline may refer to the liquid coating 604 on the surface of the nanobubble 602 (e.g., liquid coating being the scavenging material). By providing the liquid as a coating 604 on the surface of the nanobubble 602, sour gas may be treated via the nanobubble comprising a carrier gas (e.g. for forming the nanobubbles 602) and a scavenging material (e.g. the liquid coating 604 on the nanobubble surface).

In some aspects, materials, methods, and systems for improving scavenging efficiency of H₂S in reactors used in wellbore operations are provided according to one or more of the following examples. As used below, any reference to a series of examples is to be understood as a reference to each of those examples disjunctively (e.g., “Examples 1-4” is to be understood as “Examples 1, 2, 3, or 4”).

Example 1 is a method for scavenging hydrogen sulfide, the method comprising: injecting a plurality of nanobubbles into a flowline or pipeline carrying a production fluid, wherein the plurality of nanobubbles comprise an H2S scavenging material that interacts with the production fluid and removes H2S from the production fluid; outputting a cleaned production fluid containing a reduced amount or concentration of H2S compared to an untreated production fluid; and collecting the cleaned production fluid.

Example 2 is the method of example 1, wherein the nanobubbles are of a controlled size ranging from 1 nm to 1000 nm in diameter.

Example 3 is the method of any one of examples 1-2, wherein the H2S scavenging material comprises a triazine, and wherein a concentration of the triazine is between 1 ppm and 10000 ppm.

Example 4 is the method of any one of examples 1-3, wherein a concentration of the H2S scavenging material is in excess by at least 25% as compared to a removal capacity of the H2S scavenging material for the H2S in the production fluid, or wherein the reduced amount or concentration of H2S in the cleaned production fluid corresponds to removal of 99% more of the H2S from the production fluid.

Example 5 is the method of any one of examples 1-4, further comprising analyzing the cleaned production fluid and modifying a composition or condition of the plurality of nanobubbles to adjust an amount or concentration of H2S in the cleaned production fluid.

Example 6 is the method of any one of examples 1-5, wherein modifying a composition or condition of the plurality of nanobubbles comprises one or more of: adjusting a temperature of the scavenging material; or adjusting a pressure of the scavenging material injected into the flowline or pipeline; or adjusting an amount or concentration of the H2S scavenging material; or adjusting a flow rate of the plurality of nanobubbles into the flowline or pipeline.

Example 7 is the method of any one of examples 1-6, wherein the method further comprises: attaching, a at least one retention loop to the flowline or pipeline; analyzing the cleaned production fluid; and modifying a composition or condition of the plurality of nanobubbles to adjust an amount or concentration of H2S in the cleaned production fluid.

Example 8 is the method of any one of examples 1-7, wherein the plurality of nanobubbles is injected into the flowline or pipeline in combination with a carrier liquid or a carrier gas and wherein the plurality of nanobubbles is injected into a production operation or wellbore operation.

Example 9 is the method of any one of examples 1-8, wherein the carrier liquid is water, brine, or oil.

Example 10 is the method of any one of examples 1-9, wherein the carrier gas is methane or an inert gas.

Example 11 is the method of any one of examples 1-10, further comprising injecting, in combination with the plurality of nanobubbles, a surfactant, wherein the surfactant reduces an aggregation potential of the nanobubbles.

Example 12 is the method of any one of examples 1-11, wherein the surfactant is selected from a group comprising alkyl amines, alkylamine salts, alkylamidobetaines such as cocoamidopropyl betaine, trimethylallowammonium chloride, trimethylcocoammonium chloride, cocoamidopropyl betaine, amide quarternary ammonium surfactants with a chemical formula CnH2n+1CONH(CH2)2N+(CH3)3(CH3CO3- (n=9, 11, 13, 15), 2-(2-butoxyethoxy) ethanol, 2-(2-ethoxyethoxy) ethanol, 2-(2-methoxyethoxy) ethanol, 2-butoxyethanol, 2-ethoxyethanol, 2-ethoxyethyl acetate, bis(2-methoxyethyl) ether, alkoxylated nonylphenols, alkyloxylated lineral alcohols, alkyloxylated branched chain alcohols, propylene oxide condensate block copolymers, salts of aliphatic sulfonic acids, alpha-olefin sulfonate, C8 to C22 alkylethoxylate sulfate, N-(phosphonmethyl)iminodiacetic acid, or any combination thereof.

Example 13 is the method of any one of examples 1-12, wherein the method further comprises injecting a second scavenging material or a second carrier gas into the production fluid, wherein the second scavenging material at least partially removes CO2 gas from the production fluid prior to injecting a plurality of nanobubbles into the flowline or pipeline.

Example 14 is the method of any one of examples 1-13, wherein a CO2 concentration is reduced in the production fluid by at least 5% by volume to by at least 25% by volume, or greater.

Example 15 is the method of any one of examples 1-14, wherein the plurality of nanobubbles are injected into the flowline or pipeline at more than one location along the flowline or pipeline.

Example 16 is the method of any one of examples 1-15, wherein the method is employed in conventional wells, unconventional wells, wet gas wells in unconventional production, and production operations.

Example 17 is a system for scavenging hydrogen sulfide comprising: a nanobubble generator positioned along a pipeline or flowline that is exterior and parallel to the main flowline; an injection valve along the pipeline or flowline positioned immediately before the nanobubble generator, for injecting a carrier gas; and a quill, in fluid and gas communication with the pipeline or flow line and positioned exterior to the pipeline or flowline, wherein the quill is inserted into the main flowline or pipeline for injecting a plurality of nanobubbles, wherein the plurality of nanobubbles comprise a scavenging material for producing a clean production fluid.

Example 18 is the system of example 17, wherein the nanobubble generator is configured for controllably producing nanobubbles ranging from 1 nm to 1000 nm in diameter.

Example 19 is the system of any one of examples 17-18, wherein the system further includes an injection port for injecting a surfactant, wherein the surfactant interacts with the scavenging material on the surface of the nanobubbles to increase a stability of the nanobubbles, wherein the surfactant is selected from a group comprising alkyl amines, alkylamine salts, alkylamidobetaines such as cocoamidopropyl betaine, trimethylallowammonium chloride, trimethylcocoammonium chloride, cocoamidopropyl betaine, amide quarternary ammonium surfactants with a chemical formula Cn-H2n+1CONH(CH2)2N+(CH3)3(CH3CO3- (n=9, 11, 13, 15), 2-(2-butoxyethoxy) ethanol, 2-(2-ethoxyethoxy) ethanol, 2-(2-methoxyethoxy) ethanol, 2-butoxyethanol, 2-ethoxyethanol, 2-ethoxyethyl acetate, bis(2-methoxyethyl) ether, alkoxylated nonylphenols, alkyloxylated lineral alcohols, alkyloxylated branched chain alcohols, propylene oxide condensate block copolymers, salts of aliphatic sulfonic acids, alpha-olefin sulfonate, C8 to C22 alkylethoxylate sulfate, N-(phosphonmethyl)iminodiacetic acid, or any combination thereof.

Example 20 is the system of any one of examples 17-19, wherein the system further includes an injection port for injecting a second scavenging material or carrier gas into the production fluid, wherein the second scavenging material at least partially removes CO2 gas from the production fluid prior to injection of the nanobubbles into the flowline or pipeline.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A method for scavenging hydrogen sulfide, the method comprising:
injecting a plurality of nanobubbles into a flowline or pipeline carrying a production fluid, wherein the plurality of nanobubbles comprise an H₂S scavenging material that interacts with the production fluid and removes H₂S from the production fluid;
outputting a cleaned production fluid containing a reduced amount or concentration of H2S compared to an untreated production fluid; and
collecting the cleaned production fluid.

2. The method of claim 1, wherein the nanobubbles are of a controlled size ranging from 1 nm to 1000 nm in diameter.

3. The method of claim 1, wherein the H2S scavenging material comprises a triazine, and wherein a concentration of the triazine is between 1 ppm and 10000 ppm.

4. The method of claim 1, wherein a concentration of the H2S scavenging material is in excess by at least 25% as compared to a removal capacity of the H2S scavenging material for the H2S in the production fluid, or wherein the reduced amount or concentration of H2S in the cleaned production fluid corresponds to removal of 99% more of the H2S from the production fluid.

5. The method of claim 1, further comprising analyzing the cleaned production fluid and modifying a composition or condition of the plurality of nanobubbles to adjust an amount or concentration of H2S in the cleaned production fluid.

6. The method of claim 5, wherein modifying a composition or condition of the plurality of nanobubbles comprises one or more of:
adjusting a temperature of the scavenging material; or
adjusting a pressure of the scavenging material injected into the flowline or pipeline; or
adjusting an amount or concentration of the H2S scavenging material; or
adjusting a flow rate of the plurality of nanobubbles into the flowline or pipeline.

7. The method of claim 1, wherein the method further comprises:
attaching, a at least one retention loop to the flowline or pipeline;
analyzing the cleaned production fluid; and
modifying a composition or condition of the plurality of nanobubbles to adjust an amount or concentration of H2S in the cleaned production fluid.

8. The method of claim 1, wherein the plurality of nanobubbles is injected into the flowline or pipeline in combination with a carrier liquid or a carrier gas and wherein the plurality of nanobubbles is injected into a production operation or wellbore operation.

9. The method of claim 8, wherein the carrier liquid is water, brine, or oil.

10. The method of claim 8, wherein the carrier gas is methane or an inert gas.

11. The method of claim 1, further comprising injecting, in combination with the plurality of nanobubbles, a surfactant, wherein the surfactant reduces an aggregation potential of the nanobubbles.

12. The method of claim 11, wherein the surfactant is selected from a group comprising, alkyl amines, alkylamine salts, alkylamidobetaines such as cocoamidopropyl betaine, trimethylallowammonium chloride, trimethylcocoammonium chloride, cocoamidopropyl betaine, amide quarternary ammonium surfactants with a chemical formula Cn-H2n+1CONH(CH2)2N+(CH3)3·CH3CO3- (n=9, 11, 13, 15), 2-(2-butoxyethoxy) ethanol, 2-(2-ethoxyethoxy) ethanol, 2-(2-methoxyethoxy) ethanol, 2-butoxyethanol, 2-ethoxyethanol, 2-ethoxyethyl acetate, bis(2-methoxyethyl) ether, alkoxylated nonylphenols, alkyloxylated lineral alcohols, alkyloxylated branched chain alcohols, propylene oxide condensate block copolymers, salts of aliphatic sulfonic acids, alpha-olefin sulfonate, C8 to C22 alkylethoxylate sulfate, N-(phosphonmethyl)iminodiacetic acid, or any combination thereof.

13. The method of claim 1, wherein the method further comprises injecting a second scavenging material or a second carrier gas into the production fluid, wherein the second scavenging material at least partially removes CO2 gas from the production fluid prior to injecting a plurality of nanobubbles into the flowline or pipeline.

14. The method of claim 13, wherein a CO2 concentration is reduced in the production fluid by at least 5% by volume to by at least 25% by volume, or greater.

15. The method of claim 1, wherein the plurality of nanobubbles are injected into the flowline or pipeline at more than one location along the flowline or pipeline.

16. The method of claim 1, wherein the method is employed in conventional wells, unconventional wells, wet gas wells in unconventional production, and production operations.

17. A system for scavenging hydrogen sulfide comprising:
a nanobubble generator positioned along a pipeline or flowline that is exterior and parallel to the main flowline;
an injection valve along the pipeline or flowline positioned immediately before the nanobubble generator, for injecting a carrier gas; and
a quill, in fluid and gas communication with the pipeline or flow line and positioned exterior to the pipeline or flowline, wherein the quill is inserted into the main flowline or pipeline for injecting a plurality of nanobubbles, wherein the plurality of nanobubbles comprise a scavenging material for producing a clean production fluid.

18. The system of claim 17, wherein the nanobubble generator is configured for controllably producing nanobubbles ranging from 1 nm to 1000 nm in diameter.

19. The system of claim 17, wherein the system further includes an injection port for injecting a surfactant, wherein the surfactant interacts with the scavenging material on the surface of the nanobubbles to increase a stability of the nanobubbles, wherein the surfactant is selected from a group comprising alkyl amines, alkylamine salts, alkylamidobetaines such as cocoamidopropyl betaine, trimethylallowammonium chloride, trimethylcocoammonium chloride, cocoamidopropyl betaine, amide quarternary ammonium surfactants with a chemical formula CnH2n+1CONH(CH2)2N+(CH3)3·CH3CO3- (n=9, 11, 13, 15), 2-(2-butoxyethoxy) ethanol, 2-(2-ethoxyethoxy) ethanol, 2-(2-methoxyethoxy) ethanol, 2-butoxyethanol, 2-ethoxyethanol, 2-ethoxyethyl acetate, bis(2-methoxyethyl) ether, alkoxylated nonylphenols, alkyloxylated lineral alcohols, alkyloxylated branched chain alcohols, propylene oxide condensate block copolymers, salts of aliphatic sulfonic acids, alpha-olefin sulfonate, C8 to C22 alkylethoxylate sulfate, N-(phosphonmethyl)iminodiacetic acid, or any combination thereof

20. The system of claim 17, wherein the system further includes an injection port for injecting a second scavenging material or carrier gas into the production fluid, wherein the second scavenging material at least partially removes CO2 gas from the production fluid prior to injection of the nanobubbles into the flowline or pipeline.
